(19) United States
(12) Patent Application Publication
(10) Pub. No.: US 2025/0108371 A1
(43) Pub. Date: Apr. 3, 2025

(54) CAPILLARY-BASES SELECTIVE SURFACE PATTERNING

(71) Applicant: Georgia Tech Research Corporation, Atlanta, GA (US)

(72) Inventors: Hang Lu, Atlanta, GA (US); Guillaume Aubry, Atlanta, GA (US); Anna Kaehr, Atlanta, GA (US)

(21) Appl. No.: 18/904,923

(22) Filed: Oct. 2, 2024

Related U.S. Application Data
(60) Provisional application No. 63/587,226, filed on Oct. 2, 2023.

(51) Int. Cl. B01L 3/00

(52) U.S. Cl. CPC B01L 3/502707; B01L 2200/027; B01L 2200/0673; B01L 2200/12; B01L 2400/0688

(57) ABSTRACT

An exemplary embodiment of the present disclosure provides a method of delivering molecules to a region of interest in a microfluidic device. The microfluidic device can comprise a primary channel, one or more secondary channels in fluid communication with the primary channel, and a plurality of fluid chambers in fluid communication with a respective secondary channel in the one or more secondary channels. The method can comprise: providing the microfluidic device; injecting a first fluid comprising first molecules of interest in microfluidic device at a first pressure; and injecting a second fluid comprising second molecules of interest in the microfluidic device at a second pressure greater than the first pressure.

### CROSS-REFERENCE TO RELATED APPLICATIONS

This application claims the benefit of U.S. Provisional Application Ser. No. 63/587,226, filed on 2 Oct. 2023, which is incorporated herein by reference in its entirety as if fully set forth below.

### GOVERNMENT LICENSE RIGHTS

This invention was made with government support under Agreement Nos. DGE-2039655 and 1648035, awarded by National Science Foundation. The government has certain rights in the invention.

### FIELD OF THE DISCLOSURE

The various embodiments of the present disclosure relate generally to microfluidic devices and patterning the same.

### BACKGROUND

Existing technologies for selective patterning of microfluidic devices do not allow for high spatial resolution without direct contact, in a closed system, and without specialized equipment (i.e. very inexpensively). Existing technologies include contact printing or lithography-based patterning. Contact printing methods cannot work with closed systems and require manual or precision-machine for alignment of features. Advanced equipment is required for high-resolution printing. Lithography-based methods can be noncontact but require advanced optical equipment and photolabile chemicals to generate the pattern of interest; the photochemistry is also not as easily generalizable to a variety of molecules. Accordingly, there is a need for improved methods for patterning microfluidic devices.

### BRIEF SUMMARY

An exemplary embodiment of the present disclosure provides a method of delivering molecules to a region of interest in a microfluidic device. The microfluidic device can comprise a primary channel, one or more secondary channels in fluid communication with the primary channel, and a plurality of fluid chambers in fluid communication with a respective secondary channel in the one or more secondary channels. The method can comprise: providing the microfluidic device; injecting a first fluid comprising first molecules of interest in microfluidic device at a first pressure; and injecting a second fluid comprising second molecules of interest in the microfluidic device at a second pressure greater than the first pressure.

In any of the embodiments disclosed herein, the method can further comprise, prior to injecting the first fluid and second fluid, filling the microfluidic device with an immiscible fluid, wherein the immiscible fluid is immiscible with the first and second fluids of interest.

In any of the embodiments disclosed herein, the immiscible fluid can be air and/or oil.

In any of the embodiments disclosed herein, injecting the first fluid in the microfluidic device at the first pressure can result in the first fluid substantially filling the primary channel but not filling the plurality of fluid chambers.

In any of the embodiments disclosed herein, the method can further comprise allowing the first fluid to remain in the primary channel for a period of time to pattern a surface of the primary channel with the first molecules of interest.

In any of the embodiments disclosed herein, injection the second fluid in the microfluidic device at the second pressure can result in the second fluid substantially filling at least a first portion of the plurality of fluid chambers.

In any of the embodiments disclosed herein, the method can further comprise allowing the second fluid to remain in the first portion of the plurality of fluid chambers for a period of time to pattern surfaces of the first portion of the plurality of fluid chambers with the second molecules of interest.

In any of the embodiments disclosed herein, the method can further comprise injecting a third fluid comprising third molecules of interest in the microfluidic device at a third pressure greater than the first and second pressures.

In any of the embodiments disclosed herein, injection the third fluid in the microfluidic device at the third pressure can result in the third fluid substantially filling at least a second portion of the plurality of fluid chambers.

In any of the embodiments disclosed herein, the method can further comprise allowing the third fluid to remain in the second portion of the plurality of fluid chambers for a period of time to pattern surfaces of the second portion of the plurality of fluid chambers with the second molecules of interest.

In any of the embodiments disclosed herein, the one or more secondary channels can serve as inlets and outlets for the plurality of fluid chambers.

In any of the embodiments disclosed herein, the method can further comprise allowing the second fluid of interest to remain in the first portion of the plurality of chambers for a second period of time to form a second fluid coating on the first portion of the plurality of chambers.

In any of the embodiments disclosed herein, the first pressure can be less than a threshold pressure to break a capillary valve of at least a first fluid chamber of the plurality of fluid chambers.

In any of the embodiments disclosed herein, the second pressure can be greater than the threshold pressure to break the capillary valve of the first fluid chamber of the plurality of fluid chambers.

Another embodiment of the present disclosure provides a method of surface patterning a microfluidic device. The microfluidic device can comprise a primary channel, a plurality of fluid chambers, and a plurality of secondary channels. Each of the plurality of secondary channels can provide fluid communication between a respective fluid chamber and the primary channel. The method can comprise: injecting a first fluid into microfluidic device at a first pressure, such that the first fluid substantially fills the primary channel, the first fluid comprising first molecules of interest; allowing the first fluid to remain in the primary channel for a first period of time to pattern the first molecules of interest on a surface of the primary channel; injecting a second fluid into the microfluidic device at a second pressure greater than the first pressure, such that the second fluid substantially fills a first portion of the plurality of fluid chambers, the second fluid comprise second molecules of interest; and allowing the second fluid to remain in the first portion of the plurality of fluid chambers for a second period of time to pattern the second molecules of interest on a surface of the first portion of the plurality of fluid chambers.

In any of the embodiments disclosed herein, the method can further comprise, after allowing the first fluid to remain in the primary channel for the first period of time and before injecting the second fluid into the microfluidic device, removing the first fluid from the microfluidic device.

In any of the embodiments disclosed herein, the method can further comprise, prior to injecting the first fluid and injecting the second fluid, filling the microfluidic device with a third fluid that is immiscible with the first and second fluids.

In any of the embodiments disclosed herein, the first pressure can be less than a burst pressure of secondary channels corresponding to the first portion of the plurality of fluid chambers.

In any of the embodiments disclosed herein, the second pressure can be greater than or equal to the burst pressure of secondary channels corresponding to the first portion of the plurality of fluid chambers.

In any of the embodiments disclosed herein, the method can further comprise injecting a third fluid into the microfluidic device at a third pressure greater than the second pressure, such that the third fluid substantially fills a second portion of the plurality of fluid chambers. The third fluid can comprise third molecules of interest. The first and second pressures can be less than a burst pressure of secondary channels corresponding to the second portion of the plurality of fluid chambers. The third pressure can be greater than or equal to the burst pressure of secondary channels corresponding to the second portion of the plurality of fluid chambers.

In any of the embodiments disclosed herein, the molecules of interest can comprise one or more of living cells, inorganic particles, polymer particles, microparticles, cell aggregates, organoids, emobroyos, and the like.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1A provides a microfluidic device, in accordance with some embodiments of the present disclosure.

FIG. 1B provides an isolated portion of the microfluidic device shown in FIG. 1A, showing the location of the two capillary valves v1 and v2: zoomed-in view of v1 regulating chamber filling as a function of the water pressure P_{w} and the valve burst pressure P_{b}.

FIG. 1C provides a sequence of liquid transport through the channels (top row) and the corresponding surface molecular state (bottom row), in which the dashed line in (i) across the chamber indicates the location of the surface shown on the bottom row; “c” indicates the chamber location along the surface, (i) illustrates introduction of blocking agent solution at P_{w}<P_{b}, (ii) illustrates incubation as the blocking agent coats all the channels except the chamber, (iii) illustrates a washing step and degassing (illustrated with arrows), (iv) illustrates introduction of cell adhesion molecule solution at P_{w}>P_{b} and incubation so that the cell adhesion molecules coat the available surface, and (v) illustrates, after a washing step, the surface is selectively coated with adhesion molecules in the chambers.

FIGS. 2A-C illustrate the characterization of the operation of an exemplary capillary valve network, in which FIG. 2A illustrates capillary stop valve design relative to chamber dimensions, which stop valves present on both sides of the chamber, FIG. 2B illustrates three regimes of valve operation: first the chambers are empty with channel only filling (Psys<Pburst), then the chamber starts filling (Psys>Pburst), and finally the chambers are completely filled (no remaining air), and FIG. 2C illustrates valve filling regimes as a function of command pressure and valve geometry in which one dimension changed while the other dimension held constant.

FIG. 3A provides images of food dye solution initially filling channels of a microfluidic device at 0 hours (left image) and remaining in the channels after 24 hours of incubation (right image), and FIG. 3B provides plots of the fraction of empty chambers in each microfluidic device when filled with different solutions at 0 hours and 24 hours, each in accordance with some embodiments of the present disclosure.

FIG. 4A provides contrast adjusted fluorescence images for BSA FITC and BSA Texas Red, in accordance with some embodiments of the present disclosure, FIG. 4B provides a plot of intensity distributions of the two fluorescent proteins, FIG. 4C provides a plot of fluorescence intensity of BSA-FITC in patterned arrays before (serpentine channel) and after (chambers) in a capillary valve array at three time points, and FIG. 4D provides a plot of fluorescence intensity for BSA Texas Red in patterned arrays before (serpentine channel) and after (chambers) in a capillary valve array at three time points, each in accordance with some embodiments of the present disclosure.

FIG. 5A provides images of HT-1080 cells cultured on surface treated devices after cell loading and 20 hours after on-chip culture, FIG. 5B provides a plot of fraction of cells in chambers compared to total cell count in arrays 20 hours after cell loading (a higher fraction is representative of better cell retention), and FIG. 5C provides a plot of fraction of cells remaining in chambers after exposure to reverse flow for 1 minute (a high fraction is indicative of greater cell adherence), each in accordance with some embodiments of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Disclosed herein are methods for selective delivery of fluids capitalizing on the effects of capillary forces and surface geometry to achieve complex surface patterns with different molecules. The surface design includes capillary valve units that pin fluids and shape the regions of the surface exposed to the fluids. Multiple layers of capillary valve units can enable distinct regions to be exposed to different fluids and create complex surface patterning.

Embodiments of the present disclosure can enhance high-throughput screening by increasing the selectivity of target molecules, e.g., living cells or small clusters (<10) of cells for phenotype measurements at the single-cell level, to surfaces and by enabling complex diagnostic assays. Some embodiments can be utilized to selectively pattern delicate substrates such as biological samples. For example, some embodiments may be applied to differential surface coating of multiple proteins or nucleic acids, for applications such as protein-based (e.g. antibody) or nucleic acid-based (e.g. aptamer) assays and cell culture. In nonbiological domain, some embodiments may be used to control fluid behavior and transport phenomena (e.g. mass or heat transfer).

Disclosed herein are methods for 2D spatial patterning for on-chip cell culture. A capillary valve network can allow for controlling liquid transport in targeted channel areas. Using capillary forces and different pressure commands, one can sequentially flow a blocking agent first and then cell adhesion molecules to create 2D patterns for cell culture. The burst pressures of the capillary valves can be calculated to establish the operating range and demonstrate selective surface coating in hundreds of chambers arranged in arrays.

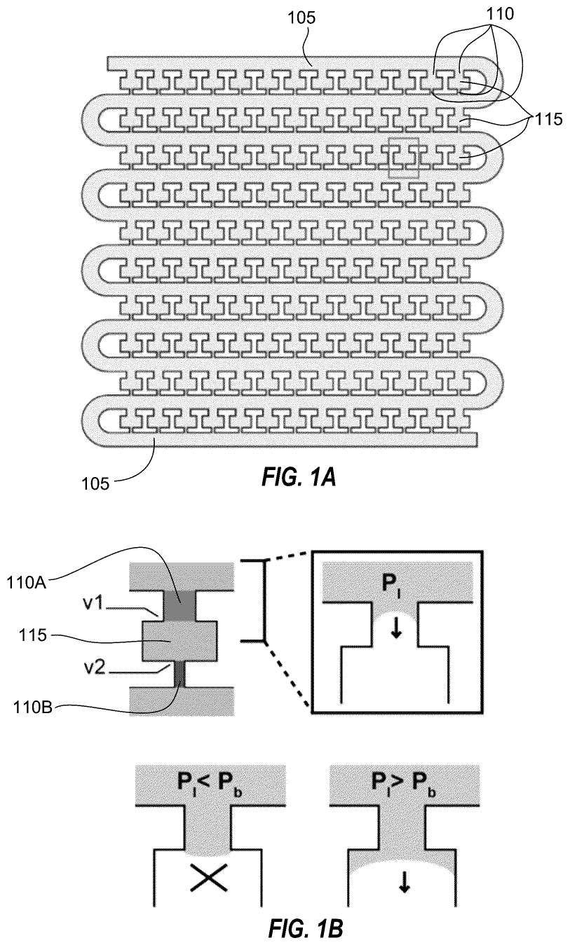

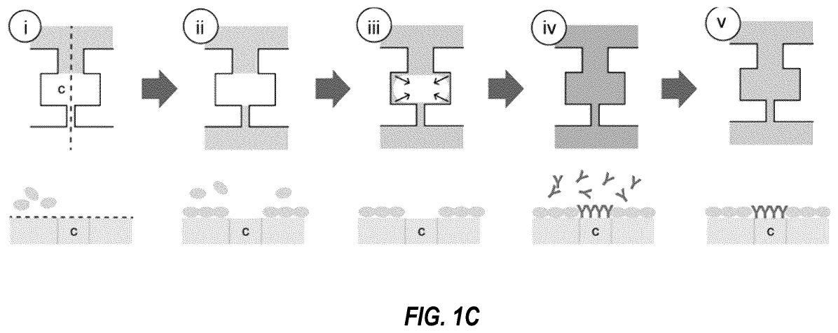

An objective of some embodiments of the present disclosure are simple, user-friendly selective surface coating technique to culture adherent cells in microfluidic arrays. The device can fulfill two functions: the first is to distribute the cells in an orderly manner; and the second is to maintain the cells in position. Some methods disclosed herein use the channel walls to trap the cells and selective surface coating to keep the cells in the chambers. The geometry of the array can play an important role in both functions. First, in some embodiments, the overall layout can borrow to hydrodynamic flow-focusing arrays and can be composed of a serpentine primary channel with crossflow units, as shown in FIG. 1A. As cells flow through the chambers, the cells can get trapped because of the smaller size of the back/secondary channels. Second, the channel geometry can play a key role in the selective surface coating process.

The mechanism of selective coating can be identical for each chamber of the array. Each chamber can be connected to the serpentine via a front secondary channel and a back secondary resistance channel, as shown in FIG. 1B. Both secondary channels can be designed so that their cross-sections are smaller than the chamber's cross-section. These features create capillary stop valves v1 and v2, characterized by their pressure burst P_{b}, that can be used to control liquid transport in specific areas. For a positive pressure applied to the liquid in the channel (Pₗ), the liquid fills in the serpentine and the front channel up to the connection with the chamber. There, the local opening can generate curvatures of the liquid-air interface where interfacial tension balances the pressure difference in liquid and in air. At low pressures (Pₗ<P_{b}), capillary forces can pin the fluid at the opening and the flow stops. When increasing the liquid pressure above the valve pressure burst, the balance is broken, and the liquid flows passed the valve. Both valves v1 and v2 can operate in a similar manner. The integration of capillary valves can be key to control the flow but, to achieve selective coating, the sequence of the protocol can be equally important.

FIG. 1C illustrates the different stages of the selective surface coating for one chamber; the same principle repeats itself across the array. In the first step, a blocking solution flows through the air-filled array at low pressure. The applied pressure Pᵢ can be lower than the valve's burst pressure P_{b}; therefore, the blocking agent fills the serpentine primary channel but not the chambers. One incubates the blocking agent on-chip for a period of time to coat the channel's surface. At the end of the incubation time, and after a washing step, buffer is introduced in the device above the valve burst pressure. The air bubbles trapped in the chambers are either pushed out through the channel or degassed through the PDMS. Then a solution of cell adhesion molecules floods the chamber and adhesion molecules absorb the chamber surface. After incubation and a washing step, the device is patterned with cell adhesion molecules in the chamber and a blocking agent in the rest of the device, creating an effective 2D array pattern.

In addition, this method can be generalized to create more complex surface patterns of more than two coatings. This can be done by changing the geometry of the network (e.g., the various secondary channels) to create capillary valves of different strengths. Then, precise control of the liquid driving pressure allows the use of three or more solutions of different surface molecules and create a larger variety of patterns, such as alternated and nested coatings. Importantly, scaling up the number of coatings does not increase the protocol complexity as one only needs to control the pressure.

Referring back to FIG. 1A-B, an exemplary microfluidic device utilized in methods of the present disclosure can comprise a primary channel 105, a plurality of secondary channels 110 (including 110A 110B), and a plurality of fluid chambers 115. As shown in FIG. 1, in some embodiments, the primary channel 105 can be arranged in a serpentine structure; however, the disclosure is not so limited. Rather, as those skilled in the art would appreciate, the primary channel 105 can have many different shapes in accordance with various embodiments of the present disclosure. Each secondary channel 110 can connect to the primary channel 105. Each of the fluid chambers 115 can be in fluid communication with the primary channel 105 via one or more secondary channels 110. For example, as shown in FIGS. 1A-B, each fluid chamber 115 can be connected to the primary channel 105 via a first secondary channel 110A that can serve as an inlet to the fluid chamber 115 and a second secondary channel 110B that can serve as an outlet to the fluid chamber 115. As discussed in more detail below, the geometries of the primary 105 and secondary 110 channels can vary in accordance with a desired application of the microfluidic device. In particular, the geometry of the secondary channels 110 can be selected to achieve a desired burst pressure (i.e., a pressure at which a fluid will flow through a secondary channel) for particular fluids. In some embodiments, the primary and/or secondary channels can be “closed” channels having only an inlet and outlet but with top, bottom, and side walls. In some embodiments, the primary and/or secondary channels can be “open” channels in which one or more of the walls (e.g., top wall) is not present.

The present disclosure provides methods of selectively surface patterning the microfluidic devices with molecules of interest. An exemplary embodiment of the present disclosure provides a method comprising injecting a first fluid in microfluidic device at a first pressure; and injecting a second fluid in the microfluidic device at a second pressure greater than the first pressure. The first fluid can comprise a first type of molecule of interest to be patterned on the surface of the primary channel 105. The first fluid can be injected at a pressure that is lower than a burst pressure of the secondary channels 110, thus precluding the first fluid from reaching the fluid chambers 115. The first fluid with the first type of molecule of interest can then incubate in the primary channel 105 where the first type of molecules of interest can pattern on an interior surface of the primary channel 105. The molecules of interest in the first fluid can pattern the surface of the primary channel 105 via many different mechanisms known in the art, including by reacting with the surfaces, physically absorbing into the surfaces, and the like.

The second fluid can comprise a second type of molecules of interest for which it is desired to pattern a surface of at least a portion of the fluid chambers 115. The second fluid can be injected at a pressure that is greater than or equal to a burst pressure of the secondary channels 110 connected to the fluid chambers 115 for which it is desirable to surface pattern with the second type of molecules of interest. Because the second fluid is injected above the burst pressure, the second fluid is able to flow into the respective fluid chambers 115. The second fluid can then be incubated in the fluid chambers 115 for a period of time whereby the second type of molecules of interest can be patterned onto the interior surface of the chambers 115. The molecules of interest in the first fluid can pattern the surface of the fluid chambers 115 via many different mechanisms known in the art, including by reacting with the surfaces, physically absorbing into the surfaces, and the like.

In some embodiments, it can be desirable to pattern a first portion of the fluid chambers 115 with one type of molecule of interest (e.g., first cell/protein type) and pattern a second portion of the fluid chambers 115 with another type of molecule of interest (e.g., second cell/protein type). In such a scenario, three fluids comprising three molecules of interest can be employed—a first to pattern the primary channel 105 (e.g., with blockers), a second to pattern the first portion of fluid chambers 115, and a third to pattern the second portion of fluid chambers 115. To do this, the geometries of the secondary channels 110 (and/or the parameters of the fluids) can be selected to alter a burst pressure of the secondary channels 110 connected to the respective first and second portions of the fluid chambers 115. For example, the secondary channels 110 of the first portion of fluid chambers 115 can have a lower or higher burst pressure than the burst pressure of the secondary channels 110 of the second portion of fluid chambers 115. The surface patterning can be performed by injecting the first fluid at a first pressure that is less than the burst pressure of each of the secondary channels 110, injecting a second fluid at a second pressure that is greater than or equal to the burst pressure of the secondary channels 110 corresponding with the first portion of fluid chambers 115 but less than a burst pressure of the secondary channels 110 corresponding to the second portion of fluid chambers 115, and then injecting a third fluid at a third pressure that is greater than or equal to the burst pressure of the secondary channels 110 corresponding to the second portion of fluid chambers 115.

Additionally, in some embodiments, prior to injecting the first fluid and second fluid into the microfluidic device, the microfluidic device can be filled with an immiscible fluid, wherein the immiscible fluid is immiscible with the first and second fluids used to pattern the device. The immiscible fluids can be many immiscible fluids, including, but not limited to air, oil, and the like. In some embodiments, the first fluid can be immiscible with the second fluid. For example, the first fluid can be an oil while the second fluid is acqueous or vice versa.

### EXAMPLES

Certain applications, devices, and methods are not described. These are provided for explanatory purposes only, however, and should not be construed as limiting the scope of the present disclosure.

### Capillary Valve Network Design:

The creation of an array of hundreds of selectively coated regions using capillary flow can be done with precise, controlled fluid transport through a plane. This may be achieved via a capillary valve network to guide the flow through a predetermined path. This step ensures the partitioning and selective coating of the serpentine primary channel with blocking molecules. One challenge lies in designing capillary valves that can sustain the liquid driving pressure during the initial filling of the array. The driving pressure must be lower than the valve burst pressure; however, to ensure rapid filling of the channels it is desirable to maximize the liquid pressure.

Understanding the pressure field in the channel can be important to design and characterize the capillary valve network. As the liquid travels through the serpentine primary channel, the hydraulic resistance increases, and the pressure drops across the liquid/air interface decreases. Therefore, for a constant pressure command, upstream valves can be exposed to a higher pressure than the downstream valves. For simplicity, some embodiments of the present disclosure utilize identical valves and use a constant command pressure.

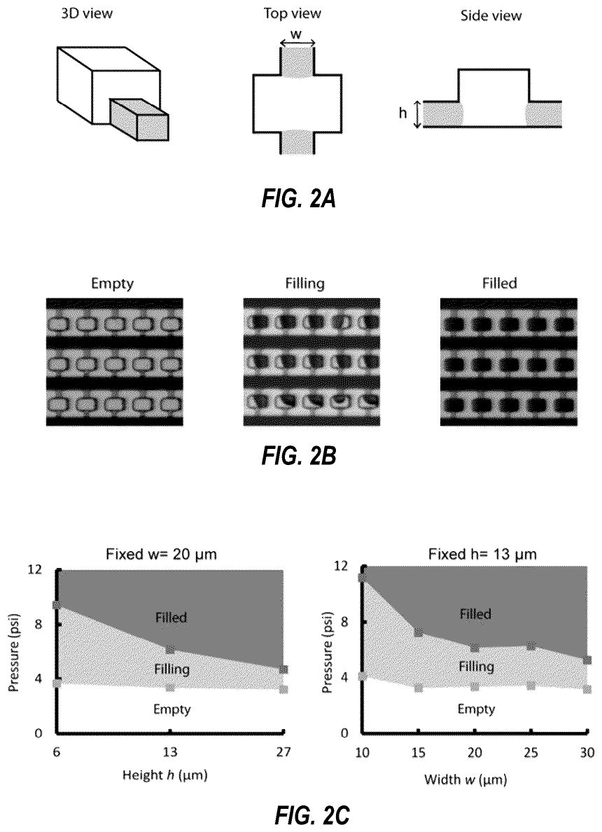

To establish the dimensions of the capillary valves, the effect of valve geometry on the valve's burst pressure can be analyzed. Several chamber arrays of uniformly sized valves were designed and varied for each array the valves' strength by adjusting the width and the height of the connecting secondary channels, as shown in FIG. 2A. Though the system shown in FIG. 2A keeps all front secondary and back secondary channels identical, in other embodiments, the geometries of the front secondary and back secondary channels can be varied. For example, for mammalian cell assays, the front secondary channels must be larger than the cells for loading the cells in the chamber and back channels must be smaller than the cells for trapping the cells inside the chambers. In the embodiment shown in FIG. 2B, in the main culture chamber, the dimensions were held constant (60 μm in width and 45 μm in height). Note that one can scale up/down these dimensions to suit any applications, as those skilled in the art would appreciate. For examples, submicron to five micron wide channels may be used to study microbes and 100 μm to millimiter wide channels may be used for beads, microrobots, organoids, embryos, and other marine larvae organisms.

Different command pressures were screened for each array geometry and the filling state was tracked. Three regimes were identified-“empty,” “filling,” and “filled”—as shown in FIG. 2B. The “empty” regime is the desired regime where the fluid stops before entering the chamber. In the “filling” regime, the valves break, and the liquid starts entering the chambers. In the “filled” regime, the liquid entirely fills the chambers. Both “filling” and “filled” regimes are failing cases.

FIG. 2C shows the phase diagram of the different regimes and enables to determine a safe operation range. The boundary between empty and filling regimes remains within 3.5-4 psi across all width and height tested. The boundary between filling and filled regimes shows a larger dependence with the valve dimensions. From these diagrams, one can extract practical guidelines for the selective surface coating protocol. For the initial filling of the array, staying below 4 psi should ensure remaining in the empty regime. Then, after the washing step, working at or above 12 psi will ensure the complete and quick filling of the chambers. These results highlight working ranges that are easily achievable. Furthermore, each regime has a range of several psi. It is therefore possible to perform the different steps manually. No precise command pressure is required to obtain the desired results. Finally, during the tested assays, it took only a few seconds to fill in the array, which makes the procedure very efficient.

### Capillary Valves Stable Enough for Protein Surface Coating Protocols:

In protein patterning and cell assay applications, surface coating can take several hours for sufficient molecule adsorption and complete surface coverage. Therefore, to apply methods of the present disclosure to protein patterning, it can be desirable for liquid partitioning to be stable for several hours. A challenge is that evaporation and absorption of water in the PDMS may affect the surface properties over time and degrade the capillary valve performances. The capillary valve performances may further change depending on the nature of proteins and other surface coating molecules that can act as surfactants and therefore alter the interfacial tension and contact angle.

To determine the impact of these factors, the stability of liquid partitioning in the capillary valve arrays was assessed over time. Different solvents were tested: water, food dye solution, 4% BSA solution, and 1% pluronic solution. BSA and pluronic are commonly used as blocking agents for surface patterning and both lower the surface tension of water. Water alone condition serves as a control, i.e. without surfactant. The solution with food dye was used for visualization purposes. The liquids were injected in the serpentine primary channels at 1 psi, then the devices were disconnected for a 24-hour incubation period.

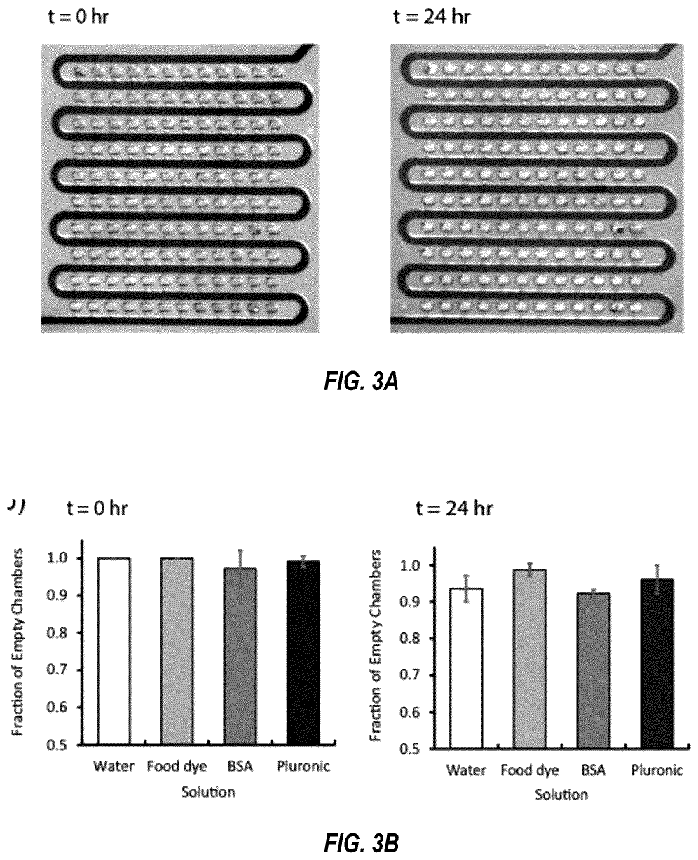

The fraction of valves that stopped the liquid at t0 and 24 hours later were characterized. 3B. FIG. 3A shows two pictures of the same array at the beginning and end of the assay for the food dye solution. One can visualize the presence of food dye in the serpentine channel and none in the chambers. FIG. 3B quantifies the fraction of functional valves at t0 and t24. Overall, the fraction of functional valves across all conditions decreases over the 24 hr period but remains above 90%. This result shows that both BSA and pluronic solutions remain in the desired “empty” regime during the entire incubation time. BSA and pluronic solutions can therefore be used as blocking agent solution in capillary network as they ensure robust partitioning of liquids during a period long enough to allow for molecules to adsorb on and fully cover the serpentine channel surface.

Demonstration of 2D Patterning with Pattern Registration

To achieve cell confinement, a clear separation between the surface treatments can be desirable. The first surface treatment aims at protecting regions not designated for cell culture. The treatment comprises in flowing a non-ligand protein (e.g. BSA) to regions delineated by the capillary valves. Then, one breaks the capillary valve barriers and performs a second surface treatment: Cell adhesion proteins are patterned in target cell culture locations where the surface is not covered by non-ligand proteins.

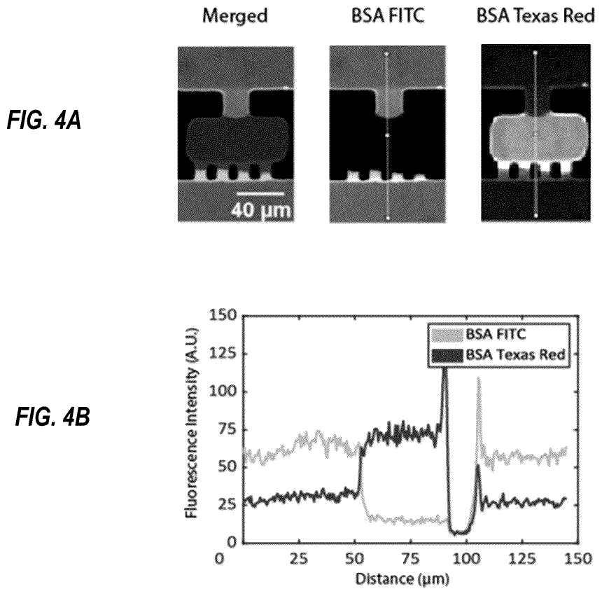

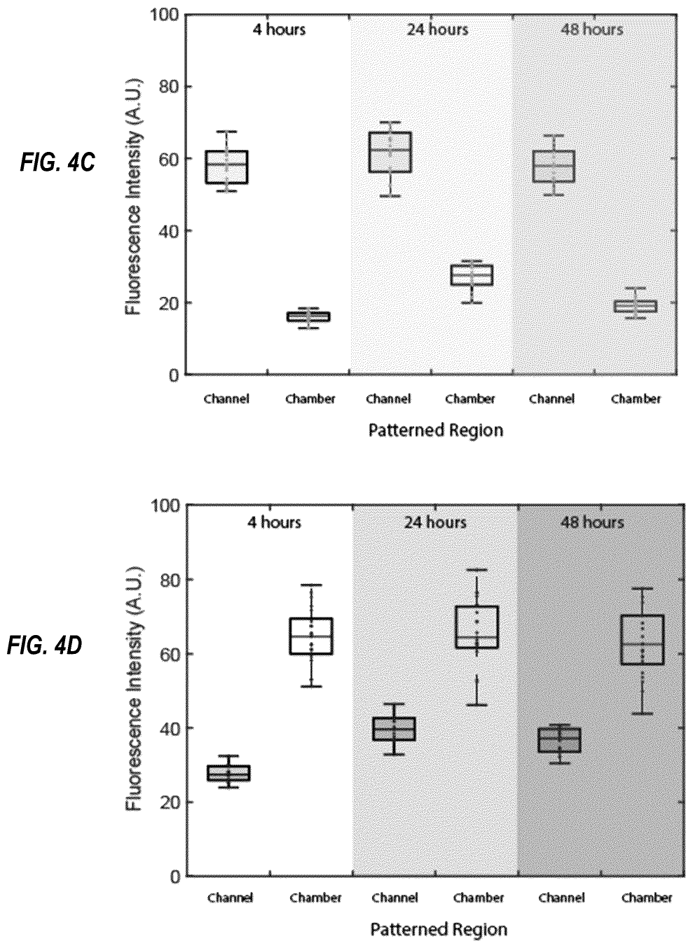

The registration of this approach was assessed by patterning BSA molecules conjugated with two different fluorophores, fluorescein isothiocyanate (FITC) and Texas Red (TXR). Confocal images of the patterned surface show uniform antibody staining with a distinct meniscus from pinning at the capillary valve (see FIG. 4A). The merge composite image also highlights there is minimal overlap between the two surface treatments. To assess the accuracy of the registration, the fluorescence intensity line-plots were quantified along each capillary valve, as shown in FIG. 4B. The results show a good definition between the region before the valve that is patterned with BSA-FITC and the region after the valve which is patterned with BSA-TXR. The transition region is less than 10 m, which is smaller than the size of a typical adherent cell. These data validate the method for its ability to pattern complex features with high precision and negligible cross contamination.

To determine the consistency and robustness of the method, the fluorescence intensity was sampled across various locations of the array and different timepoints. FIGS. 4C-D show the quantification for the BSA-FTIC signal and BSA-TXR signal respectively at 4, 24, and 48 hours after patterning the second protein. The contrast between BSA-FITC in the channel (before the capillary valve) and in the chamber (after the capillary valve) is stable over time, as is the contrast between BSA-TXR in the channel and the chamber. These data suggest that the coating strategies disclosed herein can yield controlled surface density of the coated proteins that remains stable over the course of a multiday assay on-chip.

### Application to Selective Cell Patterning:

To demonstrate the efficacy of selective protein patterning in guiding selective cell growth, the techniques disclosed herein were applied to create an adherent surface coating in the chambers only and cell culture was performed. A 4% BSA solution and a 1 μg/mL fibronectin (FN) solution were used to pattern the serpentine primary channel and chambers respectively. Control devices were coated with either 4% BSA everywhere or 1 μg/mL FN everywhere. An epithelial cell line (HT-1080 cells) was used and the devices were loaded with 50 μL of cell suspension at a density of 0.5 million cells/mL.

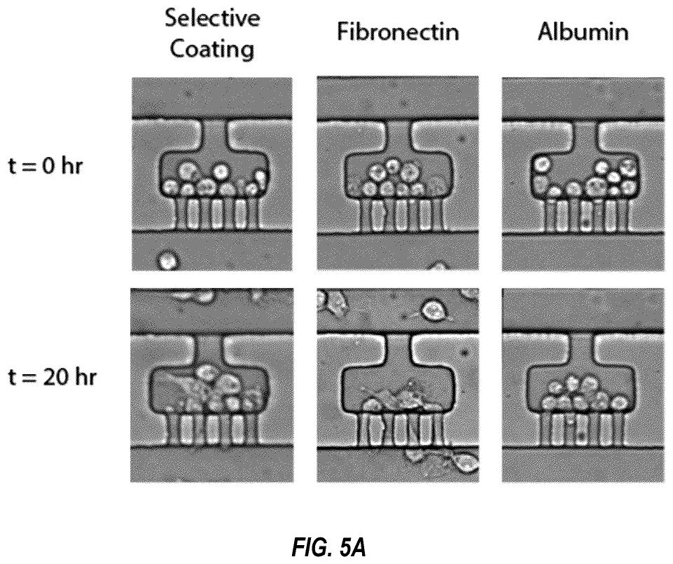

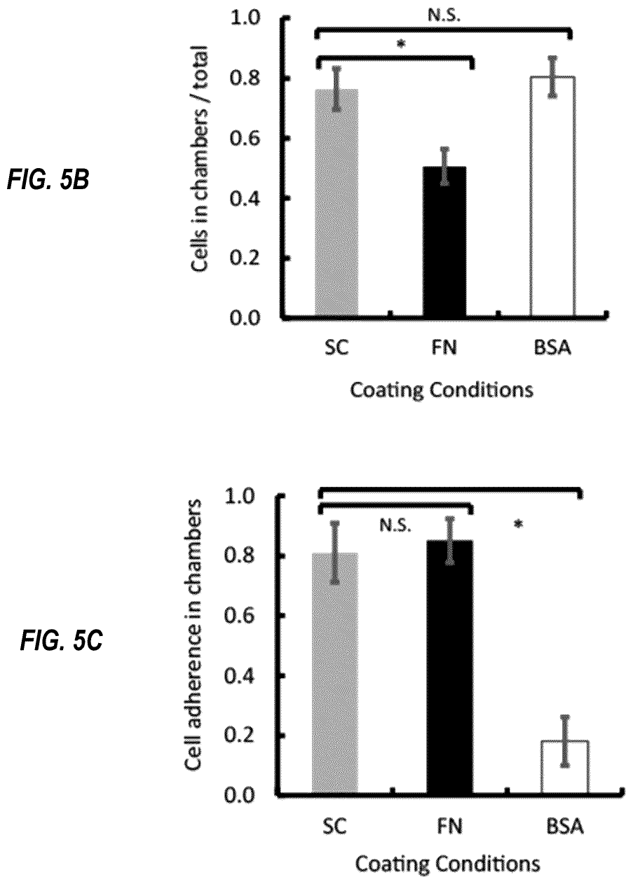

FIG. 5A shows representative images of cells in the three experimental conditions after 20 hours of on-chip culture. Live-dead cell staining established that over 80% of cells were alive in all conditions. One can see many cells in the serpentine channel for the conditions without selective surface treatment and FN everywhere. In contrast, we observe a fewer number of cells in the case of selective surface treatment and BSA everywhere. To assess cell retention, we quantified the percentage of cells in the chambers relative to the total cell count in each array after 20 hours of on-chip culture (see FIG. 5B). BSA blocking was successful as the selective coating condition shows a higher fraction of cells remaining in the chambers than the FN everywhere condition. The BSA-coated-everywhere condition shows a fraction of cells remaining in the chambers equivalent to the selective surface coating condition. One expects that the cells cannot adhere anywhere in the BSA coated device. Therefore, the cells remain in suspension and are trapped due to the same hydrodynamic flow focusing mechanism as for loading.

To confirm cell adherence or lack of adherence in the different conditions, cell circularity was measured as a metric of cell morphology. Cell circularity between the selective coating and FN everywhere conditions are not significantly different, indicating similar level of adherence. In contrast, the BSA everywhere condition has a significantly higher cell circularity, indicating less cell adherence. In addition, we tested cell adherence by reversing the flow in the devices. We quantified the fraction of cell remaining in the chamber after one minute of reverse flow (see FIG. 5C). In the BSA everywhere condition, cells flow out of the chambers and into the serpentine channel immediately after back pressure is applied. In contrast, in the selective coating and FN everywhere conditions, most cells remain in the chambers. These results demonstrate that selective coating allows for cell confinement during on-chip culture.

### Methods

Below are described certain methods of fabrication, characterization, and operation of microfluidic devices utilized in the testing examples describe above. These methods are exemplary only and should not be construed as limiting the scope of the present disclosure.

### Device Fabrication

The microfluidic devices were fabricated using conventional soft lithography techniques. The masters were obtained via successive photolithography steps with a negative photoresist (SU8, Kayaku AM) on silicon wafers. Three different masks were utilized to cast three layers of photoresist: the height of the serpentine primary channel and chambers, the height of the front secondary channel of the chamber, the height of the back secondary channel of the chamber. The height of the serpentine channel and chambers was kept at ˜40 μm across all masters. Multiple masters were created to vary the heights of the front and back channels as indicated in the text.

A mixture of 10:1 poly-dimethylsiloxane (PDMS):cross-linker was then poured on top of the wafer to obtain a thickness of ˜5 mm and cured in an oven at 70° C. overnight. Following this, blocks of PDMS were cut, access holes were punched with biopsy punches (1.5 mm diameter for the inlet, 1 mm for the outlet, Integra LifeSciences), and the PDMS blocks were bonded to coverslips via plasma treatment.

### Reagents

Bovine serum albumin (BSA), fibronectin (FN), and pluronic were obtained from Thermofisher Scientific. For studying the robustness of the protocol, food dye solution, 4% BSA solution, and 1% pluronic solution were used. The food dye was dissolved in DI water. The BSA and pluronic were dissolved in PBS. For characterizing the protein patterning, BSA conjugated to fluorescein (1% BSA-FITC) was used for main channel blocking and BSA conjugated to Texas Red (0.1% BSA-Red) was used for chamber surface treatment. For cell adhesion studies, unconjugated BSA (4% solution) was used for primary channel blocking and FN (0.01% solution) was used for chamber surface treatment. Protein solutions were prepared the day of use by dissolving protein powder in phosphate buffered saline (PBS), centrifuging the solution at 4° C., and filtering insoluble matter with a 0.20 μm syringe filter.

### Device Operation

For device design studies, deionized water was used to displace air and fill the microfluidic device with liquid. The experiments were carried out using a custom-made pressure box and MATLAB user interface to control the delivery of the liquid. Applied pressure was increased from 1 psi to 15 psi (or until complete filling of all capillary valves) in 0.25 psi increments with 10 second hold steps for system stabilization. The microfluidic device was imaged at 6.6× magnification on a dissecting scope (Zeiss Stemi SV11). Recordings were captured with a CCD camera (Lumenera, Infinity 2) and video analysis was performed in ImageJ.

### Device Characterization

To determine the phase diagrams of the filling behavior of a given array, the water/liquid pressure was increased incrementally and the status of each valve in the array characterized. The “empty”, “filling”, “filled” regime status was determined for each pressure command by assessing the fraction of valves in a particular regime and compare to a threshold of 80%. The “empty” regime goes from no pressure (an air-filled device) up to the pressure at which 80% of the valves still have no liquid entering the chambers. The “filling” regime is from the upper limit of the empty regime up to the pressure at which 80% of the valves still have some air in the chambers. The “filled” regime is defined as all pressures above the “filling” regime limit.

### Surface Treatment

Prior to use, dry devices were sterilized under UV light for 30 minutes and tubing and fittings were autoclaved. Blocking solution (4% BSA) was injected into the outlet of the device by gentle positive pressure (1 psi) via a pressure box. Pressure was applied until fluid filled the entire primary channel and the inlet of the device. The device was disconnected from the pressure source and not degassed, leaving air trapped in the chambers of the device. A 1.5 mm diameter pipette tip was inserted in the inlet and filled with 100 μL blocking solution to compensate evaporation. The device was incubated in a humidified box for 12 hours at 4° C. for optimal blocking of the main channel.

Afterwards, the blocking solution was removed from the reservoir and washed once with PBS. Fresh PBS was added to the reservoir, and the entire device was degassed with PBS to remove air from the chambers. Then 100 μL surface treatment solution (1 μg/mL FN) was added to the reservoir at the inlet and perfused via gravity flow. The device was incubated for 2 hours at 25° C. for surface treatment of the unblocked chambers. Finally, the FN solution was removed from the reservoir, washed once with PBS, and replaced with 100 μL fresh PBS prior to imaging.

### Cell Culture

The adherent epithelial HT-1080 cell line (ATCC) was cultured in DMEM medium (ATCC) supplemented with 10% fetal bovine serum albumin and 100 units/mL penicillin streptomycin (VWR). Cells were cultured in tissue culture flasks at 37° C. in a humidified 5% CO2 incubator. 50 μL cell solution was pipetted into the inlet reservoir of the pretreated device and cells were loaded into the chambers by gravity flow. Following cell loading, any remaining cell solution was removed from the reservoir and replaced with phenol-red free cell media (Thermofisher Scientific) for imaging. Live-dead staining was performed the following morning with Calcein-AM and Propidium Iodide (Thermofisher Scientific).

### Data Collection and Analysis

Confocal microscopy was performed to characterize protein and cell patterning on a Nikon sCMOS confocal microscope. Fluorescence profiles were analyzed in ImageJ. Cell patterning was also quantified in ImageJ by utilizing a binary mask of the main channel to differentiate cells in the main channel from cells in the chambers.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A method of delivering molecules to a region of interest in a microfluidic device, comprising:
providing a microfluidic device comprising:
a primary channel;
one or more secondary channels in fluid communication with the primary channel; and
a plurality of fluid chambers in fluid communication with a respective secondary channel in the one or more secondary channels;
injecting a first fluid comprising first molecules of interest in microfluidic device at a first pressure; and
injecting a second fluid comprising second molecules of interest in the microfluidic device at a second pressure greater than the first pressure.

2. The method of claim 1, further comprising, prior to injecting the first fluid and second fluid, filling the microfluidic device with an immiscible fluid, wherein the immiscible fluid is immiscible with the first and second fluids of interest.

3. The method of claim 1, wherein the immiscible fluid is air and/or oil.

4. The method of claim 1, wherein injecting the first fluid in the microfluidic device at the first pressure results in the first fluid substantially filling the primary channel but not filling the plurality of fluid chambers.

5. The method of claim 4, further comprising allowing the first fluid to remain in the primary channel for a period of time to pattern a surface of the primary channel with the first molecules of interest.

6. The method of claim 1, wherein injection the second fluid in the microfluidic device at the second pressure results in the second fluid substantially filling at least a first portion of the plurality of fluid chambers.

7. The method of claim 6, further comprising allowing the second fluid to remain in the first portion of the plurality of fluid chambers for a period of time to pattern surfaces of the first portion of the plurality of fluid chambers with the second molecules of interest.

8. The method of claim 1, further comprising injecting a third fluid comprising third molecules of interest in the microfluidic device at a third pressure greater than the first and second pressures.

9. The method of claim 8, wherein injection the third fluid in the microfluidic device at the third pressure results in the third fluid substantially filling at least a second portion of the plurality of fluid chambers.

10. The method of claim 9, further comprising allowing the third fluid to remain in the second portion of the plurality of fluid chambers for a period of time to pattern surfaces of the second portion of the plurality of fluid chambers with the second molecules of interest.

11. The method of claim 1, wherein the one or more secondary channels serve as inlets and outlets for the plurality of fluid chambers.

12. The method of claim 1, wherein the first fluid and the second fluid are immiscible.

13. The method of claim 1, wherein the first pressure is less than a threshold pressure to break a capillary valve of at least a first fluid chamber of the plurality of fluid chambers.

14. The method of claim 12, wherein the second pressure is greater than the threshold pressure to break the capillary valve of the first fluid chamber of the plurality of fluid chambers.

15. A method of surface patterning a microfluidic device, the microfluidic device comprising a primary channel, a plurality of fluid chambers, and a plurality of secondary channels, each of the plurality of secondary channels providing fluid communication between a respective fluid chamber and the primary channel, the method comprising:
injecting a first fluid into microfluidic device at a first pressure, such that the first fluid substantially fills the primary channel, the first fluid comprising first molecules of interest;
allowing the first fluid to remain in the primary channel for a first period of time to pattern the first molecules of interest on a surface of the primary channel;
injecting a second fluid into the microfluidic device at a second pressure greater than the first pressure, such that the second fluid substantially fills a first portion of the plurality of fluid chambers, the second fluid comprise second molecules of interest; and
allowing the second fluid to remain in the first portion of the plurality of fluid chambers for a second period of time to pattern the second molecules of interest on a surface of the first portion of the plurality of fluid chambers.

16. The method of claim 15, further comprising, after allowing the first fluid to remain in the primary channel for the first period of time and before injecting the second fluid into the microfluidic device, removing the first fluid from the microfluidic device.

17. The method of claim 15, further comprising, prior to injecting the first fluid and injecting the second fluid, filling the microfluidic device with a third fluid that is immiscible with the first and second fluids.

18. The method of claim 15, wherein the first pressure is less than a burst pressure of secondary channels corresponding to the first portion of the plurality of fluid chambers.

19. The method of claim 18, wherein the second pressure is greater than or equal to the burst pressure of secondary channels corresponding to the first portion of the plurality of fluid chambers.

20. The method of claim 15, further comprising injecting a third fluid into the microfluidic device at a third pressure greater than the second pressure, such that the third fluid substantially fills a second portion of the plurality of fluid chambers, the third fluid comprising third molecules of interest, wherein the first and second pressures are less than a burst pressure of secondary channels corresponding to the second portion of the plurality of fluid chambers, and wherein the third pressure is greater than or equal to the burst pressure of secondary channels corresponding to the second portion of the plurality of fluid chambers.
